(19) United States
(12) Patent Application Publication
(10) Pub. No.: US 2014/0245968 A1
(43) Pub. Date: Sep. 4, 2014

(54) Cat-Repellent Compositions and Method of Training Cats Using the Same

(71) Applicant: Martin R. DINNES, Santa Clarita, CA (US)

(72) Inventor: Martin R. DINNES, Santa Clarita, CA (US)

(21) Appl. No.: 13/781,788

(22) Filed: Mar. 1, 2013

(51) Int. Cl. A01N 65/22; A01N 65/28; A01K 29/00

(52) U.S. Cl. CPC A01N 65/22; A01K 29/00; A01N 65/28
USPC 119/712; 424/409; 424/747

(57) ABSTRACT

The invention is directed to a mixture of herbs that is cat-repellent. The mixture of herbs includes rosemary, peppermint, thyme, and clove. The herb mixture is generally contained within a sachet that further includes at least a cover which is permeable to the herbal odors. The inventive sachets may be placed around an object that has been sprayed by a cat to repel the cat and eliminate further cat-spraying.

### FIELD OF THE INVENTION

The present invention relates to cat repellent compositions formed from a mixture of herbs. The mixture of herbs creates an odor which has an impact on the behaviour of cats. The invention also relates to sachets containing the herbal mixture and a method for changing the behaviour of cats using the same.

### BACKGROUND OF THE INVENTION

Feline spraying (also called marking) occurs when a cat deposits a small amount of urine on vertical or horizontal surfaces, such as furniture, doorways and walls. The spraying cat may be seen to back into the area or up to the furniture, the tail may quiver, and the cat subsequently sprays urine on the surface. Urine marking is a natural behavior for a cat, and is not done out of spite or anger. Cats, especially male cats, instead use spraying, as well as scent rubbing, to mark their territory and to claim ownership of objects. Punishing a cat for urine spraying will only upset the cat and lead to more instances of spraying. Although neutering generally lessens the severity of marking behaviour, even neutered male cats may spray, especially if neutered late in life.

Inside private homes cat spraying is of course an unwanted behaviour, since it damages home furnishings, carpets, walls and other parts of private homes. Although each cat releases a different pheromone combination, cat urine, especially male cat urine, typically contains the cat pheromone 3-mercapto-3-methylbutan-1-ol (MMB) that gives cat urine its typical strong, pungent, ammonia-like odor. Unless the spot is thoroughly cleaned, the cat may be repeatedly drawn back to the spot, resulting in habitual cat spraying behavior at the location, which is commonly referred to in the art as a spraying-cycle. Unfortunately, cat urine odor is extremely difficult to neutralize, further exacerbating the issue.

The physical damage caused by cat urine to household furnishings results in a high economic loss. In fact, one of the main causes for cat owner's surrendering their cats to animal shelters is because of the odor and physical damage caused by indoor cat spraying. Hence there is a significant need in the art for materials and methods by which to repel cats from areas or objects, particularly areas and objects that have been marked at least once by one a cat.

Animal repellent compositions are known. An example of such a composition has been described in U.S. Pat. No. 3,474,176. This composition comprises at least one ketone which is a saturated aliphatic ketone having from 7 to 19 carbon atoms, an unsaturated aliphatic ketone having from 7 to 13 carbon atoms, or 4-tert.-amyl-cyclohexanone or 4-tert.-butyl-cyclohexanone. The composition is normally applied as a spray, comprising a solvent, to surfaces from which the animals are to be restricted. It can also be absorbed by a solid carrier material, such as paper, cloth, clay or kaolin. The composition is useful to repel any of a number of domesticated animals, such as cats and dogs, from specific areas without otherwise materially limiting their freedom of movement.

U.S. Pat. No. 4,735,803 discloses a composition comprising lemon oil and α-terpinyl methyl ether. In a preferred embodiment, the composition further comprises quinine or a quinine salt. An article or an area can be treated with the composition to repel animals, in particular dogs. The composition can be incorporated into a carrier for controlled release. Disclosed are also functional articles, e.g. garbage bags, containing the composition.

The animal repelling composition according to U.S. Pat. No. 4,853,413 comprises citronellyl nitrile, citronellol and, optionally, methyl terpenyl ether, lemon oil, caryophyllene, isopulegol, isopulegyl acetate, quinine or a quinine salt. The composition can be used in admixture with an acceptable solvent, such as ethanol, or it can be absorbed on solid material, such as kaolin.

In lieu of the continued use of such synthetic materials, there remains a need in the art for cat-repellents formed from natural ingredients.

### SUMMARY OF ADVANTAGEOUS EMBODIMENTS OF THE INVENTION

The object of the present invention thus was to provide a natural composition for repelling cats and an associated means and method for changing the behaviour of indoor domestic cats.

### DETAILED DESCRIPTION OF ADVANTAGEOUS EMBODIMENTS OF THE INVENTION

The foregoing objects are accomplished by providing a composition formed from a mixture of herbs, which are advantageously dried, coarsely-grained natural herbs. The inventive compositions are generally contained within a sachet or the like, with one or more of the sachets being placed around the previously-cat-sprayed area or object to avoid further spraying. The mixture of herbs generates an odor that over time stops cats from spraying in the area where the sachets are placed, e.g. the mixture of herbs can be used to break the cat-spraying cycle for a particular object or area.

The inventive compositions are formed from a mixture of natural herbs that more particularly includes rosemary, peppermint, thyme, and clove.

Rosemary, also known as rosmarinus officinalis, is a woody, perennial herb with fragrant, needle-like leaves. In alternative embodiments, the inventive compositions may include other species of rosmarinus herbs in addition to or in lieu of rosmarinus officinalis, including rosmarinus eriocalyx, rosmarinus tomentosus and rosemarium palaui. For ease of discussion, “rosemary” as used herein will refer to rosmarinus officinalis, unless indicated to the contrary or otherwise obvious from the context. Rosemary contains a-pinene, borneol, b-pinene, camphor, bornyl acetate, camphene, 1,8-cineole and limonene. Although not wishing to be bound by theory, Applicant respectfully submits that one or more of the foregoing rosemary components, i.e. a-pinene, borneol, b-pinene, camphor, bornyl acetate, camphene, 1,8-cineole and limonene, may be responsible for rosemary's contribution to the inventive cat-repellent composition. Hence cat-repellant compositions containing one or more of menthol, menthone, menthyl acetate, menthofuran and 1,8-cineol either in addition to or in lieu of rosemary are within the scope of the present invention, as well. Rosemary may be incorporated into the composition either as a dried herb or in oil form, specifically as an essential oil. In advantageous embodiments, the rosemary is used as a dried herb, particularly a coarsely-grained dried herb.

Peppermint, also known as Mentha X piperita or M. Balsamea, is a cross between watermint and spearmint. Peppermint has a high menthol content, and also contains menthone, menthyl acetate, menthofuran and 1,8-cineol. Although not wishing to be bound by theory, Applicant respectfully submits that one or more of the foregoing peppermint components, i.e. menthol, menthone, menthyl acetate or the like, may be responsible for peppermint's contribution to the cat-repellant composition. Hence cat repellent compositions containing one or more of menthol, menthone, menthyl acetate, menthofuran and 1,8-cineol either in addition to or in lieu of peppermint are within the scope of the present invention, as well. Peppermint is available in a number of forms, including a dried herb, an oil, or an extract. In advantageous embodiments, the peppermint is used as a dried herb, particularly a coarsely-grained dried herb.

Thyme, also known as thymus vulgaris, is a perennial herb from the mint family. The most common variety is garden thyme with gray-green leaves and a pungent minty, lemon aroma. There is believed to be abut 100 species of thyme, any of which may be of benefit within the inventive compositions. In advantageous embodiments, the thyme is garden or common thyme, which is the variety generally used in cooking. Oil of thyme is the essential oil of common thyme, and it contains a significant amount of thymol, along with p-Cytmene, myrcene, borneol and linalool.

Although not wishing to be bound by theory, Applicant respectfully submits that one or more of the foregoing thyme components, i.e. thymol, p-Cymene, myrcene, borneol and linalool or the like, may be responsible for thymes's contribution to the cat-repellent repellent composition. Hence cat-repellant compositions containing one or more of thymol, p-Cymene, myrcene, borneol and linalool, either in addition to or in lieu of thyme are within the scope of the present invention, as well. Thyme is available in a number of forms, including a dried herb, an oil, particularly an essential oil. In advantageous embodiments, the thyme is used as a dried herb, especially a coarsely-grained dried herb.

Clove, also known as syzygium aromaticum, is the flower bud of an evergreen tree in the family Myrtaceae, and belongs to the same family as allspice. Cloves further belong to the same genus as the Australian brush cherry, S. Paniculatum, and the rose apple, S. Jambos. The essential oil from cloves contains a significant amount of eugenol, i.e. 72-90%, along with acetyl eugenol, beta-caryophyllene and vanillin, crateogolic acid, tannins, such as bircornin, gallotannic acid, methyl alicylate, the flavonoids eugenin, kaempferol, rhamnetin and eugenitin, triterpenoids like oleanic acid, stigmasterol and campesterol and several sesquiterpenes. Although not wishing to be bound by theory, Applicant respectfully submits that one or more of the foregoing clove components, i.e. eugenol, acetyl eugenol, beta-caryophyllene and vanillin or the like, may be responsible for clove's contribution to the cat-repellent composition. Hence cat-repellant compositions containing one or more of eugenol, acetyl eugenol, beta-caryophyllene, vanillin, crateogolic acid, tannins, bircornin, gallotannic acid, methyl alicylate, eugenin, kaempferol, rhamnetin, eugenitin, oleanic acid, stigmasterol and campesterol and sesquiterpenes either in addition to or in lieu of cloves are within the scope of the present invention, as well. Clove is available in a number of forms, including a dried herb and an oil, particularly an essential oil. In advantageous embodiments, the cloves are used as a dried herb, especially a coarsely-grained dried herb.

The cat-repellant composition generally contains rosemary in an amount ranging from 25 to 80 wt. %; peppermint in an amount ranging from 25 to 80 wt %; thyme in an amount ranging from 10 to 36 wt% and clove in an amount ranging from 0.5 to 6 wt %. As used herein, the term “wt %” refers to the percentage by weight based upon the total weight of the cat-repellant composition, unless specifically noted to the contrary or otherwise obvious from the context.

In advantageous embodiments, rosemary and peppermint together form the major proportion of the mixture, e.g. the total rosemary and peppermint form at least 50 wt % of the cat-repellant composition, such as at least 75 wt % of the cat-repellant composition. The rosemary and peppermint are beneficially present in about equal proportions, with slightly more rosemary than peppermint being generally preferred. The rosemary:peppermint weight ratio typically ranges from 1.10:1, such as 1.5:1, specifically 1.3:1.

In particularly advantageous embodiments, the cat-repellant compositions thus contain from 30 to 50 wt % rosemary; 30 to 50 wt % peppermint; 15 to 25 wt % thyme and 1 to 5 wt % clove. In especially beneficial aspects, the inventive cat-repellant compositions contain 40.5 wt % rosemary, 39.5 wt % peppermint, 18.0 wt% thyme and 2.0 wt % clove.

The cat-repellent compositions are typically formed by admixing the rosemary, peppermint, thyme and clove in a dried form in any order, and stirring to form a generally homogeneous mixture. The dried herbs used within the inventive cat-repellent compositions are generally coarse grained. Such coarse grained dried herbs are readily available commercially, such as from grocers and the like.

Applicants have found that cat-repellent compositions including or consisting essentially of the foregoing mixture of herbs generates an odor that stops cats from spraying in the area where the sachets are placed. The odor emitted by the cat-repellent composition generally is effective either immediately or shortly after placement of the sachet within the affected area; however, a waiting period of 6 to 24 hours may be required for poorly ventilated areas or the like. The cat-repellant compositions are generally effective for an extended period of time, such as for several weeks or a month or more. Diminished efficacy may readily be determined as the cat shows a greater tolerance to the compositions and comes closer to the composition or satchet containing them. The satchets may then be disgarded, replaced or refilled with fresh cat-repellant composition.

As indicated above, the cat-repellant compositions are generally contained within a sachet. As used herein, “sachet” may include any container, bag and/or packet made from either fabric, paper and/or film, at least a portion of which allows the scent of the natural herbs to escape, i.e. at least one surface or cover of the container, bag and/or packet is permeable for herbal odors. In adavantageous embodiments, the entire sachet allows the odor of the natural herbs to escape. As used herein, the terms “scent” and “odor” are used interchangeably.

Sachets for housing the inventive cat-repellant compositions may be formed from any suitable material, including any fabric, paper or perforated plastic film. Exemplary fabrics include any woven, knit and/or non-woven fabrics, with loosely woven fabrics, such as organza, gauze or mesh fabrics used in tea-bags or the like, being preferred. Fabrics suitable for the formation of sachets include those formed from either natural, regenerated or synthetic fibers, and/or mixtures thereof, including linen fibers, cotton fibers, mixtures of cotton fibers and synthetic fibers, and so on. Suitable paper includes any filtration paper, such as paper used in air-filters, coffee-filters or tea-bags. Suitable perforated films include films formed from polyolefin, polyamide, polyester, or other synthetic polymers.

The sachets can have any desired shape and size, including rectangular, square, circular or the like. Rectangular or square shapes are generally preferred, as they are easier to produce. Sachets formed from fabric are generally made from two pieces of fabric which are glued, sealed or sewn together at their periphery to form at least three seams, and which may further include an optional zipper on one side to allow the sachet to be emptied or refilled. Sachets may similarly be produced from paper or films by gluing, heat-sealing or other methods generally known in the art. In alternative embodiments, it is also possible to combine permeable fabric and perforated film to create a containment structure for the mixture of natural herbs.

The sachets may range in size from a few inches in width and/or diameter up to afoot or more. In advantageous embodiments, the sachet is in the shape of a 3″×3″ square. In alternative advantageous embodiments, longer sachets may be formed for positioning in front of walls and the like.

The inventive sachets may optionally include one or more self-adhesive strips for securing the sachet to the floor or wall. Such self-adhesive advantageously provides low-medium adhesion, equivalent to painter's tape, so that the sachet could be removed cleanly without adhesive transfer or surface damage for up to a month or more.

To fill the inventive sachet, the cat-repellant composition, generally in the form of dried herbs, especially coarsely-grained dried herbs, is placed within the sachet formed from permeable fabric, permeable paper or of perforated plastic film through an opening provided at the sachet's periphery or the like. This opening is closed subsequent to filling the sachet via sealing, gluing, sewing or the like. Typically, about 5 to 10 grams of cat-repellant composition is placed within a 3″×3″ square sachet. Sachets having other dimensions would likewise generally be filled with about the same proportional amount of cat-repellant composition per square inch of sachet noted in the foregoing embodiment. In alternative embodiments, the essential oils of one or more of rosemary, peppermint, thyme and clove, particularly one or more essential oil (s), either alone or applied to a substrate such as paper, may be used in lieu of or in addition to the dried herb.

The invention further provides a method for changing the behaviour of cats by placing the sachets filled with the cat-repellant mixture of natural herbs in or around an area that has previously been sprayed by the cat. For example, one or more sachets may be placed on the floor in front of a spot on the wall or a door jamb that has been sprayed by a cat. The sachets are typically positioned so as to form a protective periphery around the area or object to be protected. Multiple sachets may be placed in a circular-shaped pattern or the like around the perimeter of a piece of furniture to be protected, for example. Alternatively, multiple sachets may be placed in either a semi-circular pattern, i.e. an arc-shaped pattern, or in a line on the floor in front of a spot on the wall or door jamb to be protected from spraying. A long, thin rectangular sachet may advantageously be employed to address cat-sprays on walls or door jamb, as well. The combination of herbal odors emanating from the inventive filled sachets repels the cats from the area around the sachet. An effective amount of cat-repellent composition and/or cat-repellent-filled sachets can be readily determined by placing at least one initial deposit of the composition or sachet approximately 10 to 12 inches from the area to be protected from spraying (or the cite that was previously sprayed), for example from a deposit of 5 to 10 grams of composition or a single filled-sachet, and observing the cat's behaviour. If the cat maneuvers around the initially placed composition and/or sachet in an attempt to return to the spraying-site, then additional deposits and/or filled-sachets may be placed so as to block the cat's path around the initially placed deposit and/or filled-sachet until the cat is repelled from the object or area to be protected. Over time, the cat will no longer return habitually to spray at the site.

Before placing the sachets, the walls, objects (particularly furniture, curtains or the lie), or flooring (including carpets, wood floors, vinyl, slate, tile, bricks etc.), should be thoroughly cleaned from all traces of cat urine, which assists in breaking the cat-spraying cycle. As noted above, the sachets should be placed approximately 10 to 12 inches from the wall or object, (e.g. furniture or curtains) that has been previously sprayed and the sachets are typically placed about 6 inches apart from each other, using as many as needed depending on the size of the area. Sachets can also be placed on the top of flat surfaces, such as bedding or furniture or in between the cushions on a couch or chair. This often prevents cats from jumping or sleeping on couches or chairs.

In order to increase the odor of the permeable sachet, it is advisable to rub the sides of the sachet together, although such rubbing is not required.

In alternative embodiments, the inventive sachets may be placed in or around areas or objects prior to the cat spraying, as a preventative measure.

Any soiled or spent (i.e. odourless) sachets should be discarded as soon as possible and the soiled or spend sachet either replaced by a fresh one or refilled.

By repelling the cat for a sufficient amount of time, such as for one or more months, from a specific object or particular place, the cat should not longer be drawn back to the spot, thereby eliminating the habitual cat spraying behavior at the location or object. Upon noting that the cat does not habitually return to the spot or object, the inventive sachets may be removed. If the habit/behavior of spraying is intermittently deterred or eliminated using the sachets, over time, voluntary, behavioral and habitual spraying may be eliminated permanently because the cycle of spraying (a behavioral issue) may be permanently disrupted.

As used herein, “a,” “an,” “the, “at least one,” and “one or more” are used interchangeably, and the term “and/or” means one or all of the listed elements.

Also herein, the recitations of numerical ranges by endpoints include all numbers subsumed within that range.

That which is claimed:

1. A cat-repellent composition comprising a mixture of dried, coarsely grained natural herbs, said mixture of natural herbs consisting essentially of rosemary, peppermint, thyme, and clove, said sachet comprising a cover which is permeable for herbal odors.

2. The cat-repellent composition as claimed in claim 1, wherein the mixture comprises 25 to 80 wt % rosemary, 25 to 80 wt % peppermint, 10 to 36 wt % thyme, and 0.5 to 6 wt % clove.

3. The cat-repellent composition as claimed in claim 1, wherein the mixture comprises 30 to 50 wt % rosemary, 30 to 50 wt % peppermint, 15 to 25 wt % thyme, and 1 to 5 wt % clove.

4. The cat-repellent composition as claimed in claim 1, wherein the mixture consists of 40.5 wt % rosemary, 39.5 wt % peppermint, 18.0 wt % thyme and 2.0 wt % clove.

5. The cat-repellent composition as claimed in claim 1, wherein rosemary and peppermint form at least 50 wt % of the cat-repellant composition

6. The cat-repellent composition as claimed in claim 1, wherein said rosemary, peppermint, thyme and clove are dried herbs.

7. A sachet comprising a cat-repellent composition formed from 25 to 80 wt % rosemary, 25 to 80 wt % peppermint, 10 to 36 wt % thyme, and 0.5 to 6 wt % clove.

8. The sachet as claimed in claim 7, wherein said sachet comprises fabric, paper, perforated plastic film or a combination thereof that is permeable to odors emitted by the cat-repellent composition.

9. The sachet as claimed in claim 7, wherein the sachet has at least a cover which is permeable to the odors emitted by the cat-repellent composition.

10. A method for repelling cats from an object or area comprising
(i) providing a sufficient amount of a cat-repellent composition formed from 25 to 80 wt % rosemary, 25 to 80 wt % peppermint, 10 to 36 wt % thyme, and 0.5 to 6 wt % clove to repel a cat and
(ii) placing the cat-repellent composition approximately 10 to 12 inches from the object or area and spaced about 6 inches from each other to repel a cat from the object or area.

11. The method as claimed in claim 10, wherein the composition is contained within a sachet.

12. The method as claimed in claim 11, wherein more than one sachet is provided and the sachets are spaced about 6 inches from each other.
